(19) United States
(12) Patent Application Publication
(10) Pub. No.: US 2025/0134133 A1
(43) Pub. Date: May 1, 2025

(54) PROCESS FOR PRODUCTION OF SUNFLOWER PROTEIN CONCENTRATE AND SUNFLOWER PROTEIN FLOUR

(71) Applicant: Bunge SA, Geneva (CH)

(72) Inventors: Rogerio Pereira Machado, Wentzville, MO (US); Mariusz Tadeusz Szeliga, Poznan (PL); Rodrigo Batista, Wentzville, MO (US); Agnes Sosna Sardi, Dunaharaszti (HU)

(21) Appl. No.: 18/834,374

(22) PCT Filed: Jan. 30, 2023
(86) PCT No.: PCT/US23/61541

§ 371 Date: Jul. 30, 2024

Related U.S. Application Data
(60) Provisional application No. 63/305,043, filed on Jan. 31, 2022.

(51) Int. Cl. A23J 1/14; C11B 1/10

(52) U.S. Cl. CPC A23J 1/144; C11B 1/10

(57) ABSTRACT

The present invention relates generally to improved processes for the production of sunflower protein concentrate and sunflower protein flour. In some aspects, the sunflower protein concentrate and sunflower protein flour are characterized by one or more of improved protein dispersibility, high protein content, neutral taste, an essential absence of allergens, high water holding capacity, good gelling properties, improved color.

### CROSS-REFERENCE TO RELATED APPLICATION

This application claims the benefit of priority to U.S. Provisional Application Ser. No. 63/305,043 filed on Jan. 31, 2022, the contents of which are hereby expressly incorporated by reference in their entirety.

### BACKGROUND

The field of the invention relates generally to processes for the production of sunflower protein concentrate and processes for the production of sunflower protein flour.

Sunflower seeds are an attractive raw material source for food applications because of the high protein content and protein availability. In prior art processes, value added vegetable proteins, commonly called concentrates (having a protein content of about 70%) and isolates (having a protein content of about 90% and relatively low denatured protein content), are obtained from an initial defatted or low fat flour, that is further processed to remove soluble and insoluble carbohydrates.

In a traditional commercial scale sunflower crushing facility, sunflower meal is obtained as a by-product of the oil extraction process and has a high protein content such as in the order of 32 wt. % to 38 wt. %. Sunflower meal is typically used as an animal feed ingredient. In animal feed ingredients, the proteins are denatured to a large extent, resulting in a sunflower meal with high content of insoluble proteins. Substantial sunflower protein denaturation may occur during seed conditioning, expelling (at temperatures up to 140° C.) and desolventizing/toasting steps. The objective of such steps are a combination of process demands (e.g., oil removal and/or solvent recovery) and product demands (e.g., microbe control and reduction of antinutritional factors).

Prior art processes commonly include dehulling, flaking, conditioning and oil removal by using mechanical means (e.g., pressing) and/or solvent extraction. In sunflower crushing facilities known in the art, pre-pressing is performed at high temperature, such as about 100-105° C. in order to obtain pressed oil and having as low as 17 wt. % to 22 wt. % of pressed cake oil content, and to create a proper spongy structure of the pressed cake that ensures efficient hexane percolation in solvent extraction. An example of a traditional commercial scale sunflower processing is provided in U.S. Pat. No. 8,728,542 where the disclosed processes use mechanical partial deoiling (pressing) of the dehulled sunflower seed (typically having a hull content after dehulling of about 5 wt. %) to a fat or oil content to a range of from about 10 wt. % to 35 wt. %. In general, the presence of hulls and coagulated protein facilitates a spongy structure that enables efficient oil extraction. Problematically however, the presence of hulls requires strong pressing conditions in order to reach low residual oil content of the pressed cake, such as below about 35 wt. %. Further problematically, temperatures in excess of about 60-65° C. result in sunflower protein denaturization and under prior art processing conditions the proteins become denatured and may bind with sugars in the Maillard reaction. Consequently, the protein dispersibility index value of prior art deoiled sunflower flour product is considerably reduced thereby resulting in lower functionality of the protein products in food applications.

Although prior art processes are capable of achieving less than about 2.0% by weight hull content in dehulled sunflower seeds, such as by using optical sorting machines, problematically, further processing steps such as oil and sugar extraction are difficult and, in some cases, commercially impractical due to the low hull content because the hulls serve as structural material in pressing and percolation type of extraction. Without hulls and coagulated proteins, a sponge-like pressed cake structure is generally not achieved and percolation type of extraction cannot work efficiently thereby resulting in high residual oil content (such as above 5%) of the deoiled protein material. Therefore it is difficult or commercially impractical to produce a deoiled sunflower flour having a residual oil content of less than about 1.5 wt. % that is desired for direct use as a food sunflower flour or as a raw material for concentrates and isolates.

Further problematically, sunflower seeds have a high content of polyphenols that darken in color during and after oxidation, and especially in the presence of water. The most common polyphenol is chlorogenic acid which is responsible for the green color in sunflower cakes and concentrated protein products produced by prior art process. However, sunflower protein having color contaminants is generally not suitable for use in food and beverage applications.

Yet further problematically, prior art sunflower protein has a relatively low water holding capacity that can result in texture and mouth-feel generally considered unsuitable for use in meat substitute products.

The suitability for food applications of the sunflower proteins depends on a variety of factors including, for instance and without limitation, protein concentration, protein quality, color, taste, contaminants, anti-nutritionals, and functional properties such as water holding capacity. As a result, existing sunflower meal processes are unable to supply a workable raw material for further food processing.

A need therefore exists for improved process for preparing sunflower protein flour and sunflower protein concentrate having improved characteristics such as high protein content, high protein dispersibility, high water holding capacity, and acceptable mouth-feel, color, smell, and taste.

### BRIEF DESCRIPTION

In some aspects of the present disclosure, a process for preparing sunflower protein concentrate from sunflower seed is provided, the process comprising the following steps: (1) dehulling the sunflower seed to form dehulled sunflower kernels; (2) cold pre-pressing the dehulled sunflower kernels to form a pressed cake; (3) processing the pressed cake by (a) extracting oil therefrom with an oil extraction solvent, and (b) extracting sugars and polyphenols therefrom with a sugar and polyphenol extraction solvent, in any order, to form extracted pressed cake; and (4) desolventizing the extracted pressed cake to form sunflower protein concentrate; wherein: (i) the sunflower kernels comprise oil, protein, sugars, and polyphenols; (ii) the temperature of the dehulled kernels and pressed cake is 65° C. or less, preferably from 20° C. to 65° C., during the cold pre-pressing step; (iii) the oil content of the pressed cake is from 40 wt. % to 65 wt. % on a dry basis; and (iv) the sunflower protein concentrate is characterized by having a protein content of at least 55 wt. %, or preferably from 55 wt. % to 95 wt. %, on a dry basis.

In some other aspects of the present disclosure, a process for preparing sunflower protein flour from sunflower seed is provided, the process comprising the following steps: (1) dehulling the sunflower seed to form dehulled sunflower kernels; (2) cold pre-pressing the dehulled sunflower kernels to form a pressed cake; (3) processing the pressed cake by extracting oil therefrom with an oil extraction solvent to form an extracted pressed cake; and (4) desolventizing the extracted pressed cake to form sunflower protein flour, wherein: (i) the sunflower kernels comprise oil, protein, sugars, and polyphenols; (ii) the temperature of the dehulled kernels and pressed cake is 65° C., preferably from 20° C. to 65° C. or less during the cold pre-pressing step; and (iii) the oil content of the pressed cake is from 40 wt. % to 65 wt. % on a dry basis, preferably from 50 wt. % to 65 wt. % on a dry basis.

### DETAILED DESCRIPTION

The present disclosure provides for processes for preparing sunflower protein concentrate characterized by, among other features described in more detail herein, a high protein content of, for instance, from 55 wt. % to about 95 wt. %, where wt. % is expressed on a dry matter basis . . .

The present disclosure further provides for processes for preparing sunflower protein flour characterized by, among other features described in more detail herein, a high protein dispersibility index of, for instance, from about 25% to about 50%. In some aspects, the protein content of the sunflower protein flour is from about 45 wt. % to about 70 wt. %, where wt. % is expressed on a dry matter basis.

In accordance with the present disclosure, it has been discovered that improved sunflower protein products, such as sunflower protein concentrate and sunflower protein flower described in more detail herein, can be prepared from sunflower seeds according to the present disclosure. The improved sunflower protein products are suitable for use in beverage and food applications. The products of the present disclosure may be prepared by processes comprising efficient sunflower seed dehulling, cold pressing the dehulled kernels at a temperature of 65° C. or less to form a pressed cake having an oil content of from about 40 wt. % to about 65 wt. % on a dry basis. In some aspects, improved sunflower protein flour is then produced from the pressed cake by extracting oil therefrom. In some aspects, improved sunflower protein concentrate is then produced from the pressed cake by extracting oil therefrom and by extracting sugars and polyphenols therefrom, where the oil and sugar/polyphenol extractions may be done in either order.

As used herein, “Protein Dispersibility Index” or “PDI” refers to the amount of dispersible (soluble) protein relative to the overall amount of protein within a material. PDI may be measured based on AOCS Standard Procedure Ba 10b-09 Protein Dispersibility Index, modifying protein quantification from Kjeldahl to Dumas.

As used herein, “Water Holding Capacity” or “WHC” refers to hydration capacity and is characterized by the amount of water held by a protein powder or solid material in the presence of excess water. WHC is typically expressed in grams of water per gram of sample. WHC can be measured based on the American Association of Cereal Chemists, AACC 10^{th} edition, method 56-20, “Hydration capacity of pregelatinized cereal products”. In some such aspects, a 2 g protein sample is suspended in 40 g water for 10 min and centrifuged at 1000 g for 15 minutes at 20° C. The water holding capacity is expressed in gram of bound water (that is determined via the weight of the water-saturated sediment minus the weight of the dry preparation) per gram of dry protein preparation.

As used herein, dry matter % (dm %) refers to weight percent on a dry matter basis.

### Dehulling

In any of the various aspects of the present disclosure, sunflower seeds are dehulled to produce sunflower seed kernels prior to further processing. The dehulling step may suitably be carried out by mechanical treatment methods known in the art such as, for instance and without limitation, impact dehullers, and roller mills. In some aspects, impact dehullers are used.

The sunflower seed kernels and the loosened hulls may be separated by classification. Classification may be done by methods known in the art such as, for instance and without limitation, screening, air classification and/or electrostatic separation. Screening includes, without limitation, vibrating screens and rotating drums having a sieve-like structure. Air classification includes, without limitation, air aspiration, rotary classifiers, gravitational classifiers, centrifugal classifiers, and cyclone classifiers.
After classification, some amount of hulls may be left with the seed kernels. The majority of the residual hulls may be optionally removed in an optical sorting step. Optical sorting is known in the art. See, for instance, U.S. Pat. No. 5,733,592, the entire contents of which are incorporated herein. In some such aspects, optical sensors are used to differentiate seed kernels from hulls and other contaminants based on, for instance and without limitation, seed opacity, light reflectance, and light absorbance. In some cases, optical sorting machines use optical sensors that include multiple photodetectors, such as a charged-couple device and photodiode arrays. Such sorting machines may include one or more ejector mechanisms positioned after the sensor. For instance, the ejector mechanism may include multiple air nozzles associated with one or more valves triggered by an electrical signal that is synchronized with the sensor function. In some aspects, a blast of air removes a seed kernel that meets, or that does not meet, a pre-defined selection criteria from the flow of the remaining material. In some other aspects, a blast of air removes hull pieces and other contaminants that meet, or that does not meet, a pre-defined selection criteria from the flow of the remaining material.

In any of the various dehulling aspects of the present disclosure, the dehulled sunflower kernels suitably comprise a residual hull content of 5 wt. % or less, less than 4 wt. %, less than 3 wt. %, less than 2 wt. %, less than 1 wt. %, or less than 0.5 wt. %, such from 0.1 wt. % to 5 wt. %. Dehulled sunflower purity can be adjusted in the optical sorting unit operation. Under one theory, and without being bound to any particular theory, it is believed that the protein content of the de-oiled and dehulled sunflower kernels is positively correlated with dehulled sunflower purity. The dehulled sunflower kernels further comprise, among other components, oil, protein, sugars, and polyphenols.

### Cold Pressing

In any of the various aspects of the present disclosure, the dehulled sunflower kernels are cold pre-pressed to form a pressed cake. Cold presses and associated processing techniques are known in the art. A non-limiting example of a cold press method within the scope of the present disclosure is a screw expeller press. Based on experimental evidence to date, and without being bound to any particular theory, it is believed that the cold pressing unit operation opens up the oil-bearing cells by friction generated in the press thereby preparing the sunflower kernels for efficient solvent extraction of oil, sugars, and other components therefrom.

In any of the various cold pressing aspects of the disclosure, the temperature of the seed kernels and pressed cake is 65° C. or less, 60° C. or less, or 55° C. or less during the cold pre-pressing step. Suitable temperatures include about 25° C., about 30° C., about 35° C., about 40° C., about 45° C., about 50° C., about 55° C., about 60° C., or 65° C., and any range constructed therefrom, such as from about 20° C. to about 65° C., from about 25° C. to about 65° C., from about 35° C. to about 60° C., or from about 40° C. to about 55° C. In some aspects, the oil content of the pressed cake is about 40 dry matter % (“dm %”), about 45 dm %, about 50 dm %, about 55 dm %, about 60 dm %, or about 65 dm %, and any range constructed therefrom, such as from about 40 dm % to about 65 dm %, from about 40 dm % to about 60 dm %, from about 45 dm % to about 65 dm %, from about 50 dm % to about 65 dm %, or from about 45 dm % to about 60 dm %. In some aspects, the protein content of the pressed cake is about 15 dm %, about 20 dm %, about 25 dm %, about 30 dm %, about 35 dm %, or about 40 dm %, and any range constructed therefrom, such as from about 15 dm % to about 40 dm %, from about 20 dm % to about 35 dm %, or from about 25 dm % to about 35 dm %. In some aspects, the water content of the pressed cake is about 2%, about 3%, about 4%, about 5%, about 6%, about 7%, about 8%, about 9%, about 10%, about 11%, or about 12%, and any range constructed therefrom, such as from about 2% to about 12%, or from about 4% to about 10%. In some aspects, the protein dispersibility index (“PDI”) value of the pressed cake is about 30%, about 35%, about 36%, about 37%, about 38%, about 39%, about 40%, about 41%, about 42%, about 43%, about 44%, or about 45%, and any range constructed therefrom, such as from about 30% to about 45%, from about 35% to about 45%, or from about 37% to about 43%. The pressed cake of the present disclosure may be characterized by one, two, three, or more of oil content, protein content, water content, and PDI value. Based on experimental evidence to date, it is believed that the process of the present disclosure provides for pressed cake having a higher PDI as compared to pressed cake having an oil content of less than 40 dm %.

Those skilled in the art would be enabled to optimize the cold pressing process variables necessary to achieve the pressed cake temperature and oil content ranges described herein. For instance, as demonstrated in the examples, screw expeller press shaft speed and cone setting may be suitably varied to produce a pressed cake having a residual oil content having the values and ranges within the scope of the present disclosure. Shaft speed controls seed kernel feed rate into the press, such as by way of a screw feeder. Cone setting sets the discharge area of the press resulting in the applied pressure increase needed to extract oil from the seed kernels. In presses utilizing a die at the discharge, the feed range and die opening size and opening conformation can be suitably selected to obtain a pressed cake having the required oil content. Further, certain press components, such as the discharge barrel and/or feed screws, can be cooled or heated in order to achieve cold press discharge temperatures within the scope of the present disclosure.

### Oil Extraction and Sugar and Polyphenol Extraction

Oil is extracted from pressed cake with an oil extraction solvent and sugars and polyphenols are extracted from the pressed cake with a sugar and polyphenol extraction solvent to produce extracted press cake. The oil extraction step and the sugar/polyphenol extraction step may be done in either order. In some aspects of the disclosure, oil is extracted first thereby producing sunflower protein flour. Sugars and polyphenols may then be extracted from the sunflower protein flour thereby producing sunflower protein concentrate. In some aspects of the disclosure, sugars polyphenols are extracted first, followed by oil extraction, thereby producing sunflower protein concentrate. In some aspects of the disclosure, the extraction process is characterized by the absence of a process step between the step for forming a pressed cake and the step for forming and extracted pressed cake from the pressed cake.

### Oil Extraction

Oil extraction may suitably be done by extraction methods known in the art. In some aspects, immersion extraction is used. In some such aspects, continuous immersion extraction may be done. In some aspects, countercurrent immersion extraction may be done. In any aspects, multi-stage extractions may be done.

The oil extraction solvent may be a non-polar solvent (e.g., hexane) or a highly concentrated polar protic solvent (e.g., a C₁₋₃ alcohol such as >95% ethanol) considered acceptable for food grain processing. In some aspects, the oil extraction solvent is hexane or ethanol. In one aspect, the oil extraction solvent is hexane. In one aspect, oil extraction solvent purity is at least 95 v/v %. Oil extraction is suitably done at a temperature of not more than 65° C., such as 65° C., about 60° C., about 55° C., about 50° C., about 45° C., or about 40° C., or less.

Immersion extraction is known in the art. See, for instance, U.S. Pat. No. 6,495,044 and published application number US 2016/0376204, the entire contents of each of which are incorporated herein. Varying immersion extractor designs are suitable for the practice of the present disclosure. One non-limiting example of an immersion extractor comprises a vertical cylindrical vessel having a series of slowly rotating horizontal plates used for countercurrent extraction. In such extractors, pressed cake is continuously fed to the top of the column and are caused to fall through an opening onto each plate beneath in succession. The solvent is introduced at the bottom of the column and flows counter-currently upward and exiting the at the top of the column. Another non-limiting example of an immersion extractor is a belt-type design where the pressed cake is continuously loaded onto a moving perforated extractor belt to form a bed. The bed height is kept relatively consistent by feed rate adjustment. In some such extractors, countercurrent operation involves spraying fresh extraction solvent onto the pressed cake at the section nearest the discharge end of the extractor. The first extract is collected at the bottom of that section and sequentially pumped over preceding sections to the section having the freshly loaded pressed cake. A non-limiting example of one immersion extractor is the Model IV manufactured by the Crown Iron Works (Minneapolis, Minn.). In countercurrent oil extraction aspects of the present disclosure, at least two, at least three, at least four, at least five, at least six, or at least seven sequential extractions may be done.

The solids to oil extraction solvent ratio is suitably about 1:2, about 1:3, about 1:4, about 1:5, about 1:6, about 1:7, about 1:8, about 1:9, about 1:10, or about 1:15, and any range constructed therefrom, such as from about 1:2 to about 1:15, from about 1:5 to about 1:15, or from about 1:5 to about 1:10.

In any of the various oil extraction aspects of the present disclosure, the extracted pressed cake may be desolventized. Desolventization for the extracted press cake as well as any other steps of the present disclosure may suitably be done by methods known in the art, such as for instance and without limitation, heating under partial vacuum. Desolventization can employ two strategies: high temperature-short time and/or lower temperature-long time. One desolventization objective is to minimize PDI drop during desolventization to about 20 points or less, about 15 points or less, about 10 points or less, or about 5 points or less. In the high temperature-short time desolventization (also called flash desolventization), the extracted pressed cake is desolventized in a first, optional step, at a temperature of 200° C. or less, or 190° C. or less, or 180° C. or less, or 170° C. or less, or 160° C. or less, or 150° C. or less, the solvent laden extracted pressed cake is contacted for 5 seconds or less, or 4 seconds or less, or 3 seconds or less, or 2 seconds or less, thereby evaporating at least 90%, or at least 95% of the initial solvent content. And in a second, or single step, the extracted pressed cake, containing residual solvent if the first step is applied, is processed in a secondary, or only stripper at 95° C. or less, or 90° C. or less, or 85° C. or less, or 80° C. or less, or 75° C. or less, or 70° C. or less, or 65° C. or less, or 60° C. or less, for 60 minutes or less, or 50 minutes or less, or 40 minutes or less, or 30 minutes or less, or 20 minutes or less, under partial vacuum, to achieve final specification solvent limits. In aspects, the partial vacuum is at most 100 mmHg or at most 20 mmHg. The second stage can be done in one or two steps comprising temperatures of 80° C. or less, 75° C. or less, 70° C. or less, 65° C. or less, 60° C. or less, or 55° C. or less with total time varying from 30 minutes up to 60 minutes for the sum of the stages. The desolventized extracted pressed cake may then be dried by methods known in the art. The desolventized extracted pressed cake can be directly used and/or may be optionally milled and optionally graded, such as to an average particle size of less than 500 microns, less than 400 microns, less than 300 microns, or less than 200 microns.

In aspects of the disclosure where pressed cake oil extraction, desolventization, and drying is done prior to sugar and polyphenol extraction, the product is termed sunflower protein flour. In some aspects, the oil content of the sunflower protein flour is about 0.25 dm %, about 0.5 dm %, about 1 dm %, about 1.5 dm %, about 2 dm %, about 2.5 dm %, about 3 dm %, or about 4 dm %, and any range constructed therefrom, such as from about 0.25 dm % to about 4 dm %, from about 0.5 dm % to about 2.5 dm %, or from about 1 dm % to about 2 dm %. In some aspects, the protein content of the sunflower protein flour is about 45 dm %, about 50 dm %, about 55 dm %, about 60 dm %, about 65 dm %, or about 70 dm %, and any range constructed therefrom, such as from about 45 dm % to about 70 dm %, from about 50 dm % to about 65 dm %, or from about 50 dm % to about 60 dm %, or from about 55 dm % to about 60 dm %. In some aspects, the sugar content of the sunflower protein flour is about 0.5 dm %, 1 dm %, 2 dm %, 3 dm %, about 4 dm %, about 5 dm %, about 6 dm %, about 7 dm %, about 8 dm %, about 9 dm %, or about 10 dm %, and any range constructed therefrom, such as from about 0.5 dm % to about 10 dm %, from about 3 dm % to about 10 dm %, from about 4 dm % to about 9 dm %, or from about 5 dm % to about 8 dm %. In some aspects, the water content of the sunflower protein flour is typically about 3%, about 4%, about 5%, about 6%, about 7%, about 8%, about 9%, about 10%, about 11%, about 12%, about 13%, about 14%, or about 15%, and any range constructed therefrom, such as from about 3% to about 15%, from about 6% to about 13%, or from about 8% to about 12%. In some aspects, the PDI value of the sunflower protein flour is at least 25%, at least 30%, at least 35%, at least 37%, at least 39%, at least 40%, at least 45%, or at least 50%, about 30%, about 35%, about 36%, about 37%, about 38%, about 39%, about 40%, about 41%, about 42%, about 43%, about 44%, about 45%, or about 50%, and any range constructed therefrom, such as from about 25% to about 50%, from about 25% to about 45%, from about 30% to about 45%, from about 35% to about 45%, or from about 37% to about 43%. In some aspects, the ash content of the sunflower protein flour is typically about 3 dm %, about 4 dm %, about 5 dm %, about 6 dm %, about 7 dm %, about 8 dm %, about 9 dm %, about 10 dm %, about 11 dm %, about 12 dm %, about 13 dm %, about 14 dm %, or about 15 dm %, and any range constructed therefrom, such as from about 3 dm % to about 15 dm %, from about 6 dm % to about 12 dm %, or from about 7 dm % to about 10 dm %. In some aspects, a sunflower protein flour sample having an average particle size of less than 100 μm has a color value of at least 62, at least 63, at least 64, at least 65, at least 66, at least 67, at least 68, at least 69, or at least 70 in units of the L, a, b color scale as measured by a Hunter Labscan calorimeter using a Hunter Color Flex EZ (or equivalent) to provide a reading in D65 light, with 10° observer response, where the sample is milled to below 100 μm using a UDY Mill (or equivalent), and using a Fisher brand petri dish (stackable lid, polystyrene, Cat. #FB0875712) (or equivalent). The sunflower protein flour of the present disclosure may be characterized by one, two, three, or more of oil content, protein content, sugar content, water content, ash content, PDI value, and color. Based on experimental evidence to date, it is believed that the process of the present disclosure provides for sunflower protein flour having a higher PDI as compared to sunflower protein flour prepared from pressed cake having an oil content of less than 40 dm %.

### Sugar and Polyphenol Extraction

Sugar and polyphenol extraction may suitably be done by extraction methods known in the art. In some such aspects, continuous percolation or immersion extraction may be done. In some aspects, countercurrent percolation or immersion extraction may be done. In some aspects, polyphenol and water extraction may is done by immersion extraction. In any aspect, multi-stage extractions may be done with up to 10 stages. Immersion extraction methods described elsewhere herein with respect to oil extraction are equally applicable to sugar and polyphenol extraction.

The sugar and polyphenol extraction solvent is suitably an aqueous C₁₋₃ alcohol (e.g., ethanol). In one aspect, the sugar and polyphenol extraction solvent is ethanol. The sugar and polyphenol aqueous extraction solvent is about 50 v/v % alcohol, about 55 v/v % alcohol, about 60 v/v % alcohol, about 65 v/v % alcohol, about 70 v/v % alcohol, about 75 v/v % alcohol, about 80 v/v % alcohol, about 85 v/v % alcohol, or about 90 v/v % alcohol, and any range constructed therefrom, such as from about 50 v/v % to about 90 v/v %, from about 60 v/v % to about 80 v/v %, or from about 65 v/v % to about 75 v/v %. Sugar and polyphenol extraction is suitably done at a temperature of less than 65° C., such as about 60° C., about 55° C., about 50° C., about 45° C., or about 40° C., or less. The solids to solvent ratio is suitably about 1:2, about 1:3, about 1:4, about 1:5, or about 1:6, or greater, and any range constructed therefrom, such as from about 1:2 to about 1:6, or from about 1:3 to about 1:5.

### Optional Polyphenol Extraction with Essentially Pure C₁₋₃ Alcohol

In some aspects of the present disclosure, extracted press cake may be optionally extracted with essentially pure C₁₋₃ alcohol to extract water and additional polyphenols (e.g., chlorogenic acid) prior to desolventizing and drying. As used herein, “essentially pure” refers to a C₁₋₃ alcohol of at least 95 v/v % purity. In some aspects, the C₁₋₃ alcohol is ethanol.

The optional polyphenol and water extraction may be done by conventional extraction methods known in the art such percolation extraction or immersion extraction. In some such aspects, continuous percolation or immersion extraction may be done. In some aspects, countercurrent percolation or immersion extraction may be done. In any aspects, multi-stage extractions may be done with up to about 10 stages. In some aspects, polyphenol and water extraction may is done by immersion extraction. Immersion extraction methods described elsewhere herein with respect to oil extraction are equally applicable to sugar and polyphenol extraction.

In some aspects, at least 50%, at least 60%, at least 70%, or at least 80% of the chlorogenic contained in the extracted press cake may be removed by extraction.

### Sunflower Protein Concentrate

Pressed cake that has been extracted with an oil extraction solvent and with a sugar and polyphenol extraction solvent is termed extracted press cake, regardless of the order of extraction. In some aspects of the disclosure as described in more detail herein, pressed cake is prepared by steps comprising (i) extracting oil therefrom with an oil extraction solvent to form an extracted pressed cake, (ii) desolventizing the pressed cake, (iii) extracting sugars and polyphenols from the desolventized pressed cake with a sugar and polyphenol extraction solvent to form wet sunflower protein concentrate, (iv) optionally extracting water and polyphenols from the wet sunflower protein concentrate with at least 95 v/v % pure C₁₋₃ alcohol (e.g., ethanol) to extract water and chlorogenic acid therefrom, and (v) desolventizing the wet sunflower protein concentrate to form sunflower protein concentrate. In some other aspects of the disclosure as described in more detail herein, pressed cake is processed by steps comprising (i) extracting sugars and polyphenols therefrom with a sugar and polyphenol extraction solvent to form an extracted press cake, wet sunflower protein concentrate, (ii) optionally extracting water and polyphenols from the extracted pressed cake with at least 95 v/v % pure C₁₋₃ alcohol (e.g., ethanol) to extract water chlorogenic acid therefrom, (iii) desolventizing the extracted pressed cake, (iv) extracting oil therefrom with an oil extraction solvent to form wet sunflower protein concentrate, and (v) desolventizing the wet sunflower protein concentrate to form sunflower protein concentrate. In either such aspect, each of the desolventized extracted pressed cake and sunflower protein concentrate may be independently milled and optionally graded.

In some aspects, the oil content of the sunflower protein concentrate is less than 2 dm %, less than 1.5 dm %, less than 1 dm %, about 0.25 dm %, about 0.5 dm %, about 1 dm %, about 1.5 dm %, about 2 dm %, about 2.5 dm %, about 3 dm %, or about 4 dm %, and any range constructed therefrom, such as from about 0.25 dm % to about 4 dm %, from about 0.5 dm % to about 2.5 dm %, or from about 0.5 dm % to about 1.5 dm %. In some aspects, the protein content of the sunflower protein concentrate is at least 50 dm %, at least 55 dm %, at least 60 dm %, at least 65 dm %, at least 70 dm %, at least 80 dm %, or at least 90 dm %, about 50 dm %, about 55 dm %, about 60 dm %, about 65 dm %, about 70 dm %, about 75 dm %, about 80 dm %, about 85 dm %, about 90 dm %, or about 95 dm %, and any range constructed therefrom, such as from about 50 dm % to about 75 dm %, from about 55 dm % to about 95 dm %, from about 60 dm % to about 75 dm %, from about 65 dm % to about 75 dm %, or from about 70 dm % to about 75 dm %. In some aspects, the sugar content of the sunflower protein concentrate is less than about 2 dm %, less than about 1.5 dm %, less than about 1 dm %, or less than about 0.5 dm %. In some aspects, the PDI value of the sunflower protein concentrate is less than 3%, less than 4%, less than 5%, less than 6%, less than 7%, less than 8%, at most 20%, at most 15%, at most 12%, at most 10%, about 3%, about 4%, about 5%, about 6%, about 6.5%, about 7%, about 7.5%, or about 8%, and any range constructed therefrom, such as from about 1% to about 15%, from about 2% to about 10%, from about 3% to about 8%, from about 4% to about 8%, or from about 5% to about 7%. In some aspects, the ash content of the sunflower protein concentrate is typically about 5 dm %, about 6 dm %, about 7 dm %, about 8 dm %, about 9 dm %, about 10 dm %, about 11 dm %, about 12 dm %, about 13 dm %, about 14 dm %, or about 15 dm %, and any range constructed therefrom, such as from about 5 dm % to about 15 dm %, from about 8 dm % to about 12 dm %, or from about 9 dm % to about 12 dm %. In some aspects, the water holding capacity (“WHC”) of the sunflower protein concentrate is about 3 g/g, about 3.5 g/g, about 4 g/g, about 4.5 g/g, about 5 g/g, about 5.5 g/g, about 6 g/g, about 6.5 g/g, or about 7 g/g, and any range constructed therefrom, such as for instance from about 3 g/g to about 7 g/g, from about 4 g/g to about 6 g/g, from about 5 g/g to about 7 g/g, or from about 5 g/g to about 6 g/g. In some aspects, a sunflower protein concentrate sample having an average particle size of less than 100 μm has a color value of at least 62, at least 63, at least 64, at least 65, at least 66, at least 67, at least 68, at least 69, or at least 70 in units of the L, a, b color scale as measured by a Hunter Labscan calorimeter using a Hunter Color Flex EZ (or equivalent) to provide a reading in D65 light, with 10° observer response, where the sample is milled to below 100 μm using a UDY Mill (or equivalent), and using a Fisher brand petri dish (stackable lid, polystyrene, Cat. #FB0875712) (or equivalent).

As is known in the art, the Hunterlab colorimeter is a tristimulus instrument that measures color in L, A, and B values by using a filter that spectrally approximates the CIE Standard Observer functions of the eye. The L, A, and B scales give measurements of color in visual units of color perception that relate to perceived color and color difference. The color “L” scale measures lightness and varies from 100 for perfect white to zero for black; the color “A” scale measures redness when positive and greenness when negative; and the color “B” scale measures yellowness when positive and blueness when negative. The sunflower protein concentrate of the present disclosure may be characterized by one, two, three, or more of oil content, protein content, sugar content, water content, ash content, PDI value, WHC value, and color. Based on experimental evidence to date, it is believed that the process of the present disclosure provides for sunflower protein concentrate having a higher PDI as compared to sunflower protein flour prepared from pressed cake having an oil content of less than 40 dm %. Further based on experimental evidence to date, it is believed that the process of the present disclosure provides for sunflower protein concentrate having a higher WHC as compared to sunflower protein flour prepared from pressed cake having an oil content of less than 40 dm %. The improved WHC advantageously provides for better functionality in meat applications including improved meat-like texture and mouth-feel.

### Optional Process for Preparing a Sunflower Protein Product

The present disclosure includes optional embodiments 1 to 18 as follows directed to a process for preparing a sunflower protein product.

In embodiment 1, a process for preparing a sunflower protein product from sunflower seed is provided. In some such embodiments, said process comprises: (1) dehulling the sunflower seed to form dehulled sunflower kernels; (2) cold pre-pressing the dehulled sunflower kernels to form a pressed cake; (3) processing the pressed cake by extracting oil therefrom with an oil extraction solvent to form an extracted pressed cake; (4) desolventizing the extracted pressed cake to form a sunflower protein product; and (5) optionally, drying after desolventizing. In some such embodiments, (i) the sunflower kernels comprise oil, protein, sugars, and polyphenols; (ii) the temperature of the dehulled kernels and pressed cake is 65° C., preferably from 20° C. to 65° C. or less during the cold pre-pressing step; and (iii) the oil content of the pressed cake is from 40 wt. % to 65 wt. % on a dry basis.

In embodiment 2, the dehulled sunflower kernels of embodiment 1 comprise less than 5 wt. %, or less than 4 wt. %, or less than 3 wt. %, or less than 2 wt. %, or less than 1 wt. %, or preferably from 0.1 wt. % to 5 wt. %, residual hull content.

In embodiment 3, the temperature of the dehulled kernels and pressed cake of embodiment 1 or of embodiment 2 is 65° C. or less, or 60° C. or less, or 55° C. or less, or preferably from 25° C. to 65° C., during the cold pre-pressing step.

In embodiment 4, the extracted pressed cake of any one of embodiments 1 to 3 is desolventized at a temperature of 100° C. or less to form the sunflower protein product, preferably the desolventization is performed under partial vacuum of at most 100 mmHg, preferably at most 20 mmHg.

In embodiment 5, the oil extraction solvent of any one of embodiments 1 to 4 is hexane, ethanol, or a combination thereof, preferably wherein the oil extraction solvent has a purity of at least 95%.

In embodiment 6, the oil extraction step of any one of embodiments 1 to 5 is an immersion extraction, preferably wherein the oil extraction step comprises at least two, at least three, at least four, at least five, at least six, or at least seven sequential extractions.

In embodiment 7, there are no intermediate steps between step (2) and step (3) of any one of embodiments 1 to 6.

In embodiment 8, the process of any one of embodiments 1 to 7 further comprises a step of processing the pressed cake by extracting sugars and polyphenols therefrom with a sugar and polyphenol extraction solvent to form an extracted pressed cake, before step (3), or between step (3) and step (4), or after step (5).

In embodiment 9, the sugar and polyphenol extraction solvent in embodiment 8 is aqueous ethanol having an ethanol content of from 50 v/v % to 90 v/v %, from 60 v/v % to 80 v/v %, or from 65 v/v % to 75 v/v %.

In embodiment 10, the sugar and polyphenol extraction step of embodiment 8 or embodiment 9 is an immersion extraction, preferably the sugar and polyphenol extraction step comprises at least two, at least three, at least four, at least five, at least six, or at least seven sequential extractions.

In embodiment 11, the sunflower protein product of any one of embodiments 8 to 10 is further treated with ethanol having a purity of at least 95% to extract at least 80% of a chlorogenic acid contained therein.

In embodiment 12, the sunflower protein product obtained by the process of any one of embodiments 1 to 7 is a sunflower protein flour.

In embodiment 13, the sunflower protein flour of embodiment 12, is characterized by: a Protein Dispersibility Index (PDI) that is at least 25%, at least 30%, at least 35%, at least 37%, or at least 39%, preferably from 25% to 50%; and/or a protein content that is from 45 wt. % on a dry basis to 70 wt. % on a dry basis, preferably from 50 wt. % on a dry basis to 65 wt. % on a dry basis, or preferably from 55 wt. % on a dry basis to 60 wt. % on a dry basis.

In embodiment 14, the sunflower protein product obtained by the process of any one of embodiments 8 to 11 is a sunflower protein concentrate.

In embodiment 15, the sunflower protein concentrate of embodiment 14 is characterized by: a Protein Dispersibility Index (PDI) that is at least 5%, at least 6%, at least 7% or at least 8%, preferably from 5% to 20%; and/or a protein content that is at least 55 wt. % on a dry basis, or at least 65 wt. % on a dry basis, or at least 70 wt. % on a dry basis, or preferably from 55 wt. % to 95 wt. % on a dry basis; and/or an oil content that is less than 2 wt. % on a dry basis, less than 1.5 wt. % on a dry basis, or is less than 2 wt. % on a dry basis, less than 1.5 wt. % on a dry basis, or is less than 1 wt. % on a dry basis; and/or a sugar that is less than 2 wt. % on a dry basis, is less than 1.5 wt. % on a dry basis, is less than 1 wt. % on a dry basis, or is less than 0.5 wt. % on a dry basis; and/or a water holding capacity that is from 3 g/g to 7 g/g; and/or a content of chlorogenic acid that is at most 5 mg/g, or preferably at most 2 mg/g.

In embodiment 16, the sunflower protein product of any one of embodiments 12 to 15 has a color value at least 62, or at least 63, or at least 64, or at least 65, or at least 66, or at least 67, or at least 68, or at least 69, or at least 70, as measured by L, a, b Color test by Hunter Colorimeter at less than 100 μm particle size.

In embodiment 17, the sunflower protein product of any one of embodiments 12 to 16 is used in a food product.

In embodiment 18, a food product comprises the sunflower protein product of any one of embodiments 12 to 16.

### EXAMPLES

### Example 1

Example 1 evaluated functional sunflower protein flour and concentrate production by mild cold pressing followed by hexane and ethanolic extractions. Full dehulled sunflower kernels having a hull content of about 0.1% were pressed by Farmet cold pre-press with the gap set a minimum size and at a maximum temperature of 60° C. to form a pressed cake having a fat content of about 60.2 dm % and a protein content of about 22.7 dm %.

Extraction of oil from the pressed cake to form deoiled sunflower flour was performed with hexane as follows. A 1 kg sample was combined with 3 L hexane in a glass reactor. Seven extraction stages were performed with 3 L of fresh hexane in each stage. Each stage was mixed for 20 min at a temperature of 55° C. As indicated in table 1 below, after the seven stages, the residual oil content of the deoiled sunflower flour was 1.19%, the protein content on dry matter basis was 58.6%, and the PDI was 42.5.

Hexane extraction was followed by extraction by mixing at 55° C. with 70 v/v % aqueous ethanol at a solids to solvent ratio of 1:8 to form an ethanol extracted sunflower protein concentrate. Six extraction stages were done, each having a 20 min holding time. As further indicated in table 1, the ethanol extracted sunflower protein concentrate had a 71.6 dm % protein content, a 0.96% oil content, and the PDI value dropped to 6.1%. The water holding capacity was high at 4.46.

TABLE 1

| | Moisture | Fatty Matter | Protein | PDI | Sugars |
|---|---|---|---|---|---|
| Sample | (%) | (dm %) | (dm %) | (%) | (dm %) |
| Pressed cake | 4.0 | 60.2 | 23.7 | 40.1 | — |
| sunflower | 8.7 | 1.3 | 58.6 | 42.5 | 6.3 |
| protein flour | | | | | |
| sunflower | 9.8 | 1.1 | 71.6 | 6.1 | <0.4 |
| protein | | | | | |
| concentrate | | | | | |

The results show that sugars and polyphenols were efficiently washed out during extraction due to the proper preparation steps before solvent extraction. The sample had no characteristic taste and was close to neutral with slight bitter aftertaste.

### Example 2

Example 2 was a comparative study of sunflower flour and concentrate samples.

Pressed cake samples were produced under mild pressing conditions of Example 1 and with different settings of press cake speed and cone settings. The results are presented in table 2A below where: “Moist.” Refers to moisture; “Ext. Oil” refers to extractable oil; and “Res. Oil” refers to residual oil.

TABLE 2A
Pressed Cake Results

| | Speed | Cone Setting | Moist. | Ext. Oil | Res. Oil | Protein | PDI |
|---|---|---|---|---|---|---|---|
| Sample | (rpm) | (mm) | (%) | (dm %) | (dm %) | (dm %) | (%) |
| Dehulled | — | — | 4.1 | — | 62.3 | 22.8 | 37.7 |
| SF | | | | | | | |
| Press Cake | Mild conditions | | 9.2 | 57.4 | 57.7 | 31.4 | 42.8 |
| Press Cake | 8.1 | 9.5 | 7.4 | 30.9 | 31.2 | 41.1 | 41.0 |
| Press Cake | 8.1 | 8.0 | 8.5 | 29.8 | 30.0 | 42.4 | 38.8 |
| Press Cake | 8.1 | 4.0 | 9.9 | 22.9 | 23.1 | 46.7 | 36.6 |
| Press Cake | 9.5 | 8.0 | 9.7 | 28.9 | 29.3 | 43.4 | 34.7 |
| Press Cake | 9.5 | 6.0 | 10.0 | 30.9 | 32.7 | 41.2 | 30.9 |
| Press Cake | 9.5 | 5.0 | 10.2 | 23.5 | 24.2 | 45.2 | 33.2 |

The pressed cake was observed to have the appearance, feel, and texture of and oily and sandy paste. This appearance is in contrast to the cake-like structure and appearance of a conventional pressed cake having an oil content of less than 40 wt. %.

The total fatty matter content of the pressed cake under mild conditions was 57.7% on dry matter basis.

The results show that stronger pressing conditions (higher screw speed and lower cone setting) generated lower residual fat content and lower PDI values. Visually, stronger pressing conditions generated pressed cake having darker color as compared to press cake prepared under mild conditions.

The pressed cake samples generated above were hexane extracted at a solids to solvent ratio of 1:2 in a lab scale glass reactor to form sunflower flour. Four such stages of hexane extraction were applied at 20 min/each stage, and at 55° C. The hexane extracted material was desolventized, and milled, and granulated to below an average particle size of 200 micron. The desolventized milled samples were analyzed and the results are reported in table 2B below where: “Moist.” refers to moisture; “Res.” refers to residual; and “Prot.” refers to protein.

TABLE 2B
Sunflower Flour Results

| | Moist. | Ash | Res. Oil | Prot. | PDI |
|---|---|---|---|---|---|
| Sample | (%) | (dm %) | (dm %) | (dm %) | (%) |
| Press Cake (Mild | 10.5 | 8.0 | 1.0 | 58.2 | 39.4 |
| conditions) | | | | | |
| Press Cake (8.1 rpm and | 8.7 | 9.2 | 1.18 | 53.0 | 32.8 |
| 9.5 mm) | | | | | |
| Press Cake (8.1 rpm and | 8.7 | 9.3 | 0.8 | 58.8 | 27.7 |
| 9.5 mm) | | | | | |
| Press Cake (8.1 rpm and | 8.1 | 9.3 | 0.8 | 58.6 | 27.0 |
| 9.5 mm) | | | | | |
| Press Cake (8.1 rpm and | 8.6 | 9.5 | 1.4 | 59.2 | 25.4 |
| 9.5 mm) | | | | | |
| Press Cake (8.1 rpm and | 8.4 | 9.2 | 2.6 | 57.2 | 25.6 |
| 9.5 mm) | | | | | |
| Press Cake (8.1 rpm and | 8.5 | 9.2 | 1.5 | 57.6 | 27.5 |
| 9.5 mm) | | | | | |

The results show that the PDI value of the sunflower flour product that was prepared for solvent extraction under mild cold pressing conditions is considerably higher as compared to the other sunflower flour products that were prepared under stronger 5 pressing conditions.

### Example 3

The desolventized unmilled flour samples of example 2 were extracted with aqueous EtOH 70% at a solids to solvent ratio of 1:8 in a lab scale glass reactor to form a protein concentrate. Four such extraction stages were applied at 20 min for each 10 stage and at 55° C. The ethanol extracted material was desolventized and then milled and granulated to an average particle size of below 200 micron. Samples of the milled protein concentrate material were analyzed and the results are reported in table 3.

TABLE 3
Protein Concentrate Results

| | Moist. | Ash | Prot. | PDI | WHC |
|---|---|---|---|---|---|
| Sample | (%) | (dm %) | (dm %) | (%) | (g/g) |
| Press Cake (Mild conditions) | 11.1 | — | 70.2 | 8.3 | 5.1 |
| Press Cake (8.1 rpm and 9.5 | 12.9 | 11.0 | 72.3 | 6.7 | 4.4 |
| mm) | | | | | |
| Press Cake (8.1 rpm and 9.5 | 11.7 | 10.9 | 72.5 | 3.6 | 4.3 |
| mm) | | | | | |
| Press Cake (8.1 rpm and 9.5 | 11.3 | 10.9 | 72.1 | 3.5 | 4.0 |
| mm) | | | | | |
| Press Cake (8.1 rpm and 9.5 | 10.9 | 10.6 | 72.7 | 5.3 | 4.4 |
| mm) | | | | | |
| Press Cake (8.1 rpm and 9.5 | 11.2 | 10.1 | 70.3 | 5.0 | 4.5 |
| mm) | | | | | |
| Press Cake (8.1 rpm and 9.5 | 11.3 | 10.6 | 71.1 | 4.9 | 4.0 |
| mm) | | | | | |

The results show that the PDI value of the sunflower protein concentrate product which was prepared for solvent extraction under mild cold pressing conditions (having a residual oil content of about 58 dm %) is considerably higher as compared to the sunflower protein concentrates that were prepared under stronger pressing conditions (having a residual oil content range of from about 23 dm % to about 33 dm %).

The results further show that protein concentrate sample that was prepared for solvent extraction by mild pressing conditions resulted in the highest water holding capacity of 5.1 g water/g protein, that has advantage in alternative meat application.

### Example 4

Sunflower protein concentrate prepared according to Example 3 was extracted with 95 v/v % ethanol.

The Example 4 results are reported in the table below where “SPC” refers to sunflower protein concentrate, “Part. Size” refers to particle size Dv (50), and “Emul. Strength” refers to emulsion strength.

| | Part. | Emul. | Gel |
|---|---|---|---|
| Sample | Size (nm) | Strengh (g) | Strength (g) |
| SPC, Before 95% EtOH washes | 403 | 54.73 | 632.49 |
| SPC, After 95% EtOH washes | 329 | 124.48 | 425.48 |

### Example 5

About 9,000 kg of fully dehulled sunflower kernel was processed as follows.

In Step A, the dehulled sunflower kernels were pressed in a mechanical press with drive speed set at 40 Hz, feed rate of 3.8 kg/min, with shaft cooler set at 19° C. to generate oil and pressed cake. The pressed cake submitted for oil extraction.

In Step B, The pressed cake oil extraction was performed using an immersion extractor with 7-stages, being using hexane as solvent. In this step the feed rate was 0.9 kg/min, the ratio of solids to solvent was 1:3, the residence time was 2.5 h, and the solvent temperature set at 60° C. The collected miscella (comprising solvent, lipids and minor non-polar compounds) was distilled to recover solvent, and the lipids and minor compounds were discarded. The de-fatted sunflower kernels were desolventized at a temperature of 71° C., a partial vacuum of 10 mmHg, and with retention time of 15 min. The de-fatted and desolventized sunflower kernel were submitted for ethanol extraction for removal of sugars therefrom and further protein concentration.

In Step C, ethanol extraction was performed using an immersion extractor with 7-stages, using 67 v/v % aqueous ethanol as the solvent. The feed rate was 0.55 kg/min, the ratio of solids to solvent was 1:5, the residence time was 2.5 h, and the solvent temperature was 74° C. The miscella (comprising solvent, sugars, and minor polar compounds) was distilled to recover solvent, and the sugars and minor polar compounds were discarded. The sunflower kernel concentrate was submitted for a second ethanol extraction for the purposes of drying and removing phenolic compounds (e.g., chlorogenic acid).

In Step D, the second ethanol extraction was done in a 5-stage immersion extractor with an ethanol concentration of greater than 95 v/v %. The extraction conditions were 2.5h, 71C and solvent ratio 5:1 (solvent/mass). The sunflower kernel protein concentrate was desolventized at a temperature of 82° C., a partial vacuum of 10 mmHg, and with a retention time of 15 min.

The results are reported in the Table below for the Step C product (after 67% EtOH extraction) and the Step D product (after 95% EtOH extraction).

| | Step C product | Step D product |
|---|---|---|
| Protein (dm %) | 69.9 | 68.9 |
| PDI (% of protein on dm basis) | 4.1 | 14.0 |
| Total fat by GC (%) | 1.8 | 1.0 |
| Color L | 65.2 | 80.6 |
| Color A | 1.18 | −0.33 |
| Color B | 15.8 | 11.3 |
| Moisture (%) | 10.4 | 4.5 |
| Chlorogenic acid (mg/g) | 3.54 | 1.63 |

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A process for preparing sunflower protein concentrate from sunflower seed, the process comprising the following steps:
(1) dehulling the sunflower seed to form dehulled sunflower kernels;
(2) cold pre-pressing the dehulled sunflower kernels to form a pressed cake;
(3) processing the pressed cake by (a) extracting oil therefrom with an oil extraction solvent, and (b) extracting sugars and polyphenols therefrom with a sugar and polyphenol extraction solvent, in any order, to form extracted pressed cake; and
(4) desolventizing the extracted pressed cake to form sunflower protein concentrate;
wherein:
(i) the sunflower kernels comprise oil, protein, sugars, and polyphenols;
(ii) the temperature of the dehulled kernels and pressed cake is 65° C. or less, during the cold pre-pressing step;
(iii) the oil content of the pressed cake is from 40 wt. % to 65 wt. % on a dry basis; and
(iv) the sunflower protein concentrate is characterized by having a protein content of at least 55 wt. %, on a dry basis.

2. The process of claim 1, wherein the dehulled sunflower kernels comprise less than 5 wt. %, or less than 4 wt. %, or less than 3 wt. %, or less than 2 wt. %, or less than 1 wt. %, residual hull content.

3. The process of claim 1, wherein the temperature of the dehulled kernels and pressed cake is 65° C. or less, or 60° C. or less, or 55° C. or less during the cold pre-pressing step.

4. The process of claim 1, wherein:
(i) the oil content of the sunflower protein concentrate is less than 2 wt. % on a dry basis, less than 1.5 wt. % on a dry basis, or is less than 1 wt. % on a dry basis;
and/or
(ii) the protein content of the sunflower protein concentrate is at least 65 wt. % on a dry basis, or at least 70 wt. % on a dry basis; and/or
(iii) wherein the sugar content of the sunflower protein concentrate is less than 2 wt. % on a dry basis, is less than 1.5 wt. % on a dry basis, is less than 1 wt. % on a dry basis, or is less than 0.5 wt. % on a dry basis; and/or
(iv) the sunflower protein concentrate is characterized by a water holding capacity of from 3 g/g to 7 g/g.

5. The process of claim 1, wherein the sunflower protein concentrate has a protein dispersibility index (PDI) of at most 20%, or at most 15%, or at most 12%, or at most 10%.

6. The process of claim 1, wherein the extracted pressed cake is desolventized at a temperature of 100° C. or less to form sunflower protein concentrate, and/or the extracted pressed cake is desolventized under partial vacuum of at most 100 mmHg.

7. The process of claim 1, further comprising a drying step after the desolventizing step. 8 (Original) The process of claim 7, wherein the sunflower protein concentrate has a color value of at least 62, or at least 63, or at least 64, or at least 65, or at least 66, or at least 67, or at least 68, or at least 69, or at least 70, as measured by L, a, b Color test by Hunter Colorimeter at less than 100 μm particle size.

9. The process of claim 1, wherein the processing step comprises extracting oil from the pressed cake followed by extracting sugars and polyphenols therefrom to form the extracted press cake.

10. The process of claim 1, wherein the processing step comprises extracting sugars and polyphenols from the pressed cake followed by extracting oil therefrom to form the extracted press cake.

11. The process of claim 1, wherein (a) the oil extraction solvent is hexane, ethanol, or a combination thereof, and (b) the oil extraction solvent has a purity of at least 95%, or a combination thereof.

12. The process of claim 1, wherein the oil extraction step is an immersion extraction.

13. The process of claim 1, wherein the sugar and polyphenol extraction solvent is aqueous ethanol having an ethanol content of from 50 v/v % to 90 v/v %, from 60 v/v % to 80 v/v %, or from 65 v/v % to 75 v/v %.

14. The process of claim 1, wherein the sugar and polyphenol extraction step is an immersion extraction.

15. The process of claim 1, wherein the sunflower kernels further comprise chlorogenic acid, and wherein the process further comprises the following order of steps: (a) desolventizing and drying the extracted pressed cake;
and (b) extracting the desolventized and dried extracted pressed cake with ethanol having a purity of at least 95% to extract at least 80% of the chlorogenic acid contained therein.

16. The process of claim 1, wherein there are no intermediate steps between step (2) and step (3).

17. A sunflower protein concentrate obtainable by the process of claim 1.

18. A process for preparing sunflower protein flour from sunflower seed, the process comprising the following steps:
(1) dehulling the sunflower seed to form dehulled sunflower kernels;
(2) cold pre-pressing the dehulled sunflower kernels to form a pressed cake;
(3) processing the pressed cake by extracting oil therefrom with an oil extraction solvent to form an extracted pressed cake; and
(4) desolventizing the extracted pressed cake to form sunflower protein flour, wherein:
(i) the sunflower kernels comprise oil, protein, sugars, and polyphenols;
(ii) the temperature of the dehulled kernels and pressed cake is 65° C., during the cold pre-pressing step; and
(iii) the oil content of the pressed cake is from 40 wt. % to 65 wt. % on a dry basis.

19. The process of claim 18, wherein the dehulled sunflower kernels comprise less than 5 wt. %, or less than 4 wt. %, or less than 3 wt. %, or less than 2 wt. %, or less than 1 wt. % residual hull content.

20. The process of claim 18, wherein the temperature of the dehulled kernels and pressed cake is 65° C. or less, or 60° C. or less, or 55° C. or less during the cold pre-pressing step.

21. The process of claim 18, wherein the protein dispersibility index of the sunflower protein flour is at least 25%, at least 30%, at least 35%, at least 37%, or at least 39%.

22. The process of claim 18, wherein the protein content of the sunflower protein flour is from 45 wt. % on a dry basis to 70 wt. % on a dry basis.

23. The process of claim 18, wherein the extracted pressed cake is desolventized at a temperature of 100° C. or less to form sunflower protein flour, and/or the extracted pressed cake is desolventized under partial vacuum.

24. The process of claim 18, further comprising a drying step after the desolventizing step.

25. The process of claim 24, wherein the sunflower protein flour has a color value at least 62, or at least 63, or at least 64, or at least 65, or at least 66, or at least 67, or at least 68, or at least 69, or at least 70, as measured by L, a, b Color test by Hunter Colorimeter at less than 100 μm particle size.

26. The process of claim 18, wherein (a) the oil extraction solvent is hexane, ethanol, or a combination thereof, and (b) the oil extraction solvent has a purity of at least 95%, or a combination thereof.

27. The process of claim 18, wherein the oil extraction step is an immersion extraction.

28. The process of claim 18, wherein there are no intermediate steps between step (2) and step (3).

29. A sunflower protein flour obtainable by the process of claim 18.
